(19) United States
(12) Patent Application Publication
(10) Pub. No.: US 2020/0065551 A1
(43) Pub. Date: Feb. 27, 2020

(54) OPTICAL FINGERPRINT RECOGNITION ASSEMBLY, DISPLAY DEVICE, AND TERMINAL

(71) Applicant: GUANGDONG OPPO MOBILE TELECOMMUNICATIONS CORP., LTD., Dongguan (CN)

(72) Inventors: Le Yang, Dongguan (CN); Haiping Zhang, Dongguan (CN)

(21) Appl. No.: 16/671,848

(22) Filed: Nov. 1, 2019

Related U.S. Application Data
(63) Continuation of application No. PCT/CN2018/085214, filed on Apr. 28, 2018.

(30) Foreign Application Priority Data
May 12, 2017 (CN) 201710342842.9

(51) Int. Cl. G06K 9/00; G06K 9/20

(52) U.S. Cl. CPC G06K 9/00046; G06K 9/0004; G06K 9/209

(57) ABSTRACT

The present disclosure provides an optical fingerprint recognition assembly. The optical fingerprint recognition assembly includes a light source and a fingerprint module. The fingerprint module includes a prism, an image sensor, a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor. The present disclosure further provides a display device and a terminal.

### CROSS-REFERENCE TO RELATED APPLICATIONS

This application is a continuation of International Application No. PCT/CN2018/085214, filed on Apr. 28, 2018, which claims priority to Chinese Patent Application No. 201710342842.9, filed on May 12, 2017, the entire disclosures of which are incorporated herein by reference.

### TECHNICAL FIELD

The present disclosure relates to the technology field of electronic apparatuses, and more particularly to an optical fingerprint recognition assembly, a display device, and a terminal.

### BACKGROUND

With the development of technology, at present, mobile phones and tablet computers generally have a fingerprint unlocking function. Existing fingerprint recognition devices generally include capacitive fingerprint recognition devices, optical fingerprint recognition devices, and thermal sensing fingerprint recognition devices. The optical fingerprint recognition devices are widely used since the optical fingerprint recognition devices are reliable and cheap.

For a terminal having the optical fingerprint recognition device, an organic light-emitting layer of a display screen of the terminal is used for emitting lights for fingerprint collection. It is found that the display screen provided with the optical fingerprint recognition device has a short service life due to that the display screen needs to frequently emit lights for frequent fingerprint unlocking. Accordingly, usage of the terminal may be affected.

### SUMMARY

The present disclosure provides an optical fingerprint recognition assembly, a display device, and a terminal.

In order to solve the above technical problem, the present disclosure provides an optical fingerprint recognition assembly. The optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

The present disclosure further provides a display device including a display screen and an optical fingerprint recognition assembly attached to the display screen. The optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

The present disclosure further provides a terminal including a display device. The display device includes a display screen and an optical fingerprint recognition assembly attached to the display screen The optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

### BRIEF DESCRIPTION OF THE DRAWINGS

To better illustrate the technical solutions of the present disclosure, the c will briefly illustrate the accompanying drawings described in the embodiments. Obviously, the following described accompanying drawings merely illustrate some embodiments of the present disclosure. Those skilled in the art may obtain other accompanying drawings according to the described accompanying drawings without creative efforts.

FIG. 1 is a schematic view of an optical fingerprint recognition assembly according to a first embodiment of the present disclosure.

FIG. 2 is a schematic view illustrating an arrangement of a number of light sources of the optical fingerprint recognition assembly illustrated in FIG. 1.

FIG. 3 is a schematic view illustrating another arrangement of the number of light sources of the optical fingerprint recognition assembly illustrated in FIG. 1.

FIG. 4 is a schematic view of the optical fingerprint recognition assembly illustrated in FIG. 1, illustrating that the optical fingerprint recognition assembly is provided with a flexible circuit board.

FIG. 5 is a schematic view of a terminal according to a second embodiment of the present disclosure.

FIG. 6 is a cross-sectional view of the terminal illustrated in FIG. 5 taken along a line I-I.

### DETAILED DESCRIPTION

The technical solutions of embodiments of the present disclosure will be described clearly and completely in combination with the accompanying drawings of the embodiments of the present disclosure.

A terminal 300 according to the embodiments of the present disclosure may be any apparatus having communication and storage functions such as a smart device having a network function. The smart device may be a tablet computer, a mobile phone, an e-reader, a remote controller, a personal computer (PC), a notebook computer, an in-vehicle device, an internet TV, a wearable device, or the like.

An optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

An angel of incidence formed by the light emitted from the light source and a line perpendicular to the fingerprint touch surface ranges from 0 degree to 8 degrees.

The light source surrounds the fingerprint module.

The light source includes a number of light emitting diodes (LEDs). The LEDs surround the fingerprint module and are evenly spaced apart from each other.

The fingerprint module has a cross section including two opposite long sides and two opposite short sides. The two short sides are connected between the two long sides.

The light source includes six LEDs. Each of the long sides is provided with two of the LEDs. Each of the short sides is provided with one of the LEDs.

The fingerprint module has a cross section in a round shape.

The light source includes four LEDs evenly disposed at a side surface of the fingerprint module.

The light source is a number of infrared light sources. The infrared light sources surround the fingerprint module and are evenly spaced apart from each other.

The fingerprint module has a cross section including two opposite long sides and two opposite short sides. The two short sides are connected between the two long sides.

The optical fingerprint recognition assembly further includes a substrate. The light sources and the fingerprint module both are encapsulated on the substrate.

The optical fingerprint recognition assembly further includes a flexible circuit board and a substrate disposed on the flexible circuit board. The fingerprint module is encapsulated on the substrate, and the light source is disposed on the flexible circuit board.

The prism, the image sensor, and the fingerprint controller are encapsulated via an epoxy molding compound plastic to form the fingerprint module.

A display device includes a display screen and an optical fingerprint recognition assembly attached to the display screen. The optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

The display screen includes a rear surface facing away from the display screen. The rear surface defines a recess. The optical fingerprint recognition assembly is received in the recess defined in the rear surface.

An orthographic projection of the recess on the display screen falls in a display area of the display screen for displaying images.

The rear surface is provided with a light-shielding layer made of light-shielding material.

A terminal includes a display device. The display device includes a display screen and an optical fingerprint recognition assembly attached to the display screen. The optical fingerprint recognition assembly includes a light source and a fingerprint module. The fingerprint module includes a prism, an image sensor, and a fingerprint controller. The prism, the image sensor, and the fingerprint controller are encapsulated together. The prism includes a fingerprint touch surface configured to receive a fingerprint. The light source is disposed outside the fingerprint module and configured to emit lights reaching the fingerprint touch surface where a fingerprint to be recognized exists. Total reflection occurs when the lights reach the fingerprint to be recognized. Lights formed via the total reflection pass through the prism and reach the image sensor. The image sensor acquires a fingerprint image according to the lights formed via the total reflection. The fingerprint controller recognizes the fingerprint image received from the image sensor.

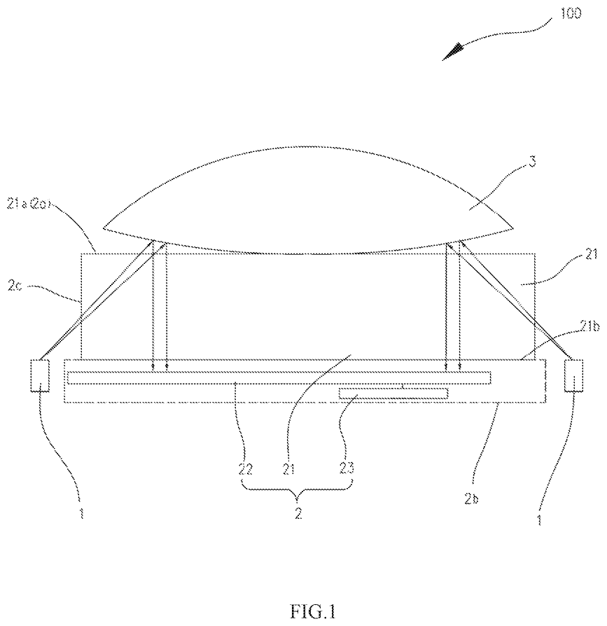

As illustrated in FIG. 1, an optical fingerprint recognition assembly 100 according to a first embodiment of the present disclosure is provided. The optical fingerprint recognition assembly 100 includes a number of light sources 1 and a fingerprint module 2. The light sources 1 are configured to emit lights for fingerprint recognition. The light sources 1 cooperate with the fingerprint module 2 to perform the fingerprint recognition as follows. Lights emitted from the light sources 1 reach a fingerprint touch surface 21a of a prism 21 where a fingerprint to be recognized exists. Total reflection occurs when the lights reach the fingerprint. Lights formed via the total reflection pass through the prism 21 and reach an image sensor 22. The image sensor 22 acquires a fingerprint image according to the lights formed via the total reflection. A fingerprint controller 23 recognizes the fingerprint image received from the image sensor 22.

In the embodiment, as illustrated in FIG. 1, the fingerprint module 2 includes the prism 21, the image sensor 22, and the fingerprint controller 23. The prism 21, the image sensor 22, and the fingerprint controller 23 of the fingerprint module 2 are encapsulated together. In this way, the fingerprint module 2 may be in a block shape as whole. The fingerprint module 2 includes an upper surface 2a, a lower surface 2b opposite the upper surface 2a, and a side surface 2c connected between the upper surface 2a and the lower surface 2b. A distance between the upper surface 2a and the lower surface 2b of the fingerprint module 2 is defined as a height of the fingerprint module 2. A distance between two positions of the side surface 2c of the fingerprint module 2 is defined as a width of the fingerprint module 2, where the distance between the two positions is the largest among distances between any other positions of the side surface 2c.

It can be understood that, the prism 21, the image sensor 22, and the fingerprint controller 23 may be encapsulated together via an epoxy molding compound (EMC) plastic. A process of encapsulating the fingerprint module 2 may not affect normal operations of optical components, such as the prism 21.

The prism 21 includes the fingerprint touch surface 21a configured to receive a fingerprint and an incident light surface 21b configured to allow the lights formed via total reflection to pass through. The fingerprint touch surface 21a is the upper surface 2a of the fingerprint module 2. The fingerprint recognition is performed when the fingerprint touch surface 21a of the prism 21 is pressed by a user's finger portion 3 containing a fingerprint. The image sensor 22 and the fingerprint controller 23 are disposed below the prism 21, that is, the image sensor 22 and the fingerprint controller 23 are close to the incident light surface 21b of the fingerprint module 2. In this way, the image sensor 22 may acquire lights reflected to the incident light surface 21b of the prism 21 and convert optical signals into electrical signals. The electrical signals are transmitted to the fingerprint controller 23 for processing. The image sensor 22 and the fingerprint controller 23 form the lower surface 2b of the fingerprint module 2. It can be understood that, the lower surface 2b of the fingerprint module is a surface facing away from the upper surface 2a.

As illustrated in FIG. 1, the light sources 1 are disposed outside the fingerprint module 2. The lights emitted from the light sources 1 may reach the fingerprint touch surface 21 of the prism 21 and be used for fingerprint recognition, that is, the optical fingerprint recognition assembly 100 may independently emit lights. When being applied to a display device or a terminal, the optical fingerprint recognition assembly 100 may emit lights independently, rather than that the optical fingerprint recognition assembly 100 is illuminated via other devices.

It can be understood that, an angle of incidence formed by the light emitted from the light source 1 and a line perpendicular to the fingerprint touch surface 21a ranges from 0 degree to 8 degrees. When the angle of incidence falls in the range from 0 degree to 8 degrees, it can be ensured that the light emitted from the light source 1 may be well reflected by the fingerprint touch surface 21a where the fingerprint to be recognized exists, such that the image sensor 22 can acquire an accurate fingerprint image, thereby improving an accuracy of fingerprint recognition.

For a further improvement, as illustrated in FIG. 1, the light sources 1 surround the fingerprint module 2. For example, the light sources 1 surround the side surface 2c of the fingerprint module 2 to decrease the height of the optical fingerprint recognition assembly 100, such that when the optical fingerprint recognition assembly 100 is applied to a display device or a terminal, the display device or the terminal can be made to be thin.

It can be understood that, the light sources 1 may include a number of light emitting diodes (LEDs). The LEDs surround the fingerprint module 2 and are evenly spaced apart from each other. In an alternative embodiment, the light sources 1 may be a number of infrared light sources. The infrared light sources surround the fingerprint module 2 and are evenly spaced apart from each other.

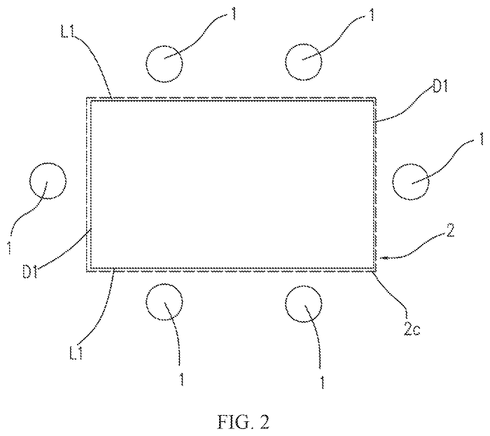

In one embodiment, as illustrated in FIG. 2, the fingerprint module 2 has a cross section in a rectangular shape, that is, the cross section of the fingerprint module 2 includes two opposite long sides L1 and two opposite short sides D1. The two short sides D1 are connected to the two long sides L and located between the two long sides L1. The light sources 1 may be six LEDs or six infrared light sources. Each of the long sides L1 is provided with two LEDs or two infrared light sources. Each of the short sides D1 is provided with one LED or one infrared light source. The arrangement of the light sources 1 may ensure that the fingerprint touch surface 21a may be illuminated with sufficient lights, which is beneficial for the fingerprint recognition.

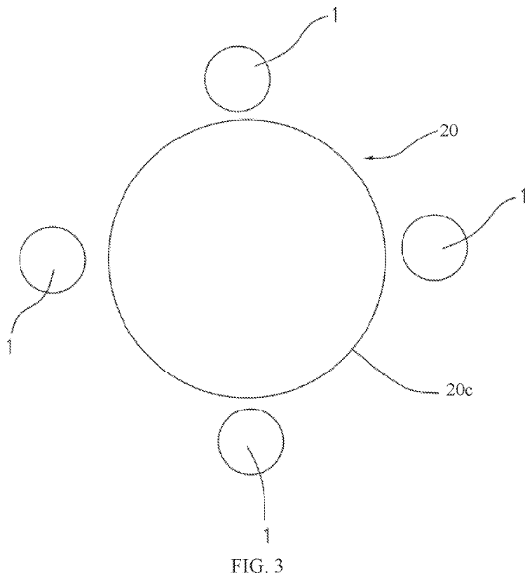

In another embodiment, as illustrated in FIG. 3, a fingerprint module 20 in this embodiment is similar to that in the FIG. 2 and FIG. 3 except that the fingerprint module 20 may have a cross section in a round shape. The light sources 1 may be four LEDs or four infrared light sources evenly disposed at a side surface 20c of the fingerprint module 20. The arrangement of the light sources 1 may ensure that a fingerprint touch surface of a prism of the fingerprint module 20 may be illuminated with sufficient lights, which is beneficial for the fingerprint recognition.

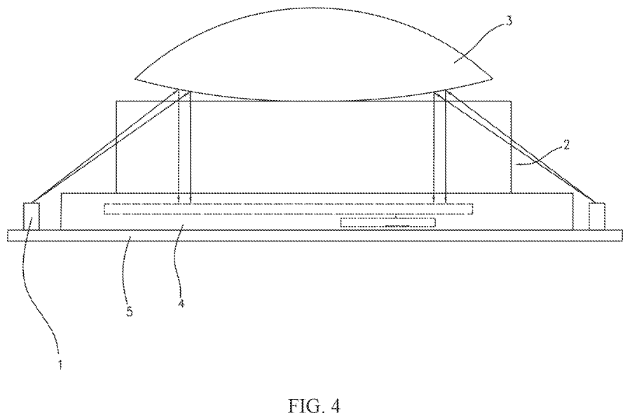

Furthermore, as illustrated in FIG. 1, the optical fingerprint recognition assembly 100 further includes a substrate 4. The light sources 1 and the fingerprint module 2 both are encapsulated on the substrate 4. The substrate 4 is a rigid, and can support the light sources 1 and the fingerprint module 2. The LEDs or the infrared light sources 1 surround the fingerprint module 2, and the light sources 1 are encapsulated on the substrate 4 via the epoxy molding compound (EMC) plastic, that is, the light sources 1 and the fingerprint module 2 both are encapsulated on the substrate 4. When using the optical fingerprint recognition assembly 100, the substrate 4 is mounted in a corresponding location of the display device or the terminal. Of course, in other embodiments, as illustrated in FIG. 4, the optical fingerprint recognition assembly 100 further includes a flexible circuit board 5 and the substrate 4 disposed on the flexible circuit board 5. The fingerprint module 2 is encapsulated on the substrate 4. The light sources 1 are disposed on the flexible circuit board 5. The light sources 1 can be fixed without encapsulating both the fingerprint module 2 and the light sources 1 on the substrate 4.

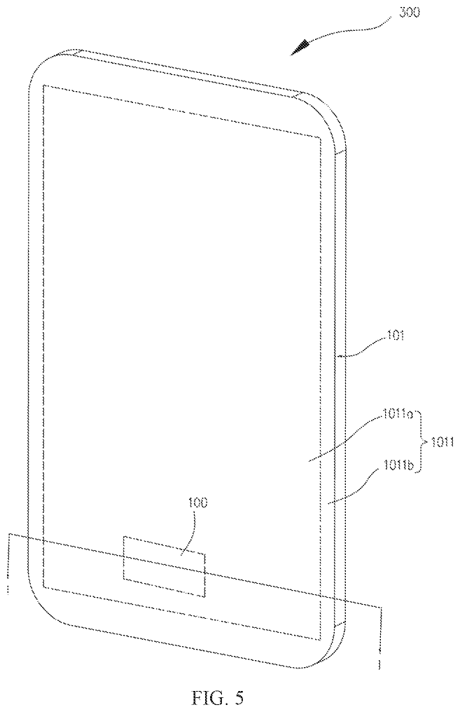

As illustrated in FIG. 5, a terminal 300 is provided according to a second embodiment of the present disclosure. The terminal 300 includes a display device 200. The display device 200 includes a display screen 101 and the optical fingerprint recognition assembly 100. For details of the optical fingerprint recognition assembly 100, reference may be made to the first embodiment of the present disclosure. For the terminal 300, by means of the optical fingerprint recognition assembly 100 as described above, the display screen 101 does not need to emit lights, and thus service life of the display screen 101 is prolonged.

In the embodiment, as illustrated in FIG. 5, the display screen 101 includes a display surface 1011 and a rear surface 1012 opposite the display surface 1011. The display surface 1011 includes a display area 1011a configured to display images and a non-display area 1011b incapable of displaying images. The rear surface 1012 is opposite the display surface 1011. The rear surface 1012 is provided with a light-shielding layer made of light-shielding material. Since the light-shielding layer is thin, a shape of the rear surface 1012 may be substantially the same as that of the light-shielding layer. It can be understood that, the light-shielding material may be foams. Since the rear surface 102 blocks lights, traces in the display screen 101 may be invisible when the display area 1011a does not display images, thereby further improving display performance of the display device 200.

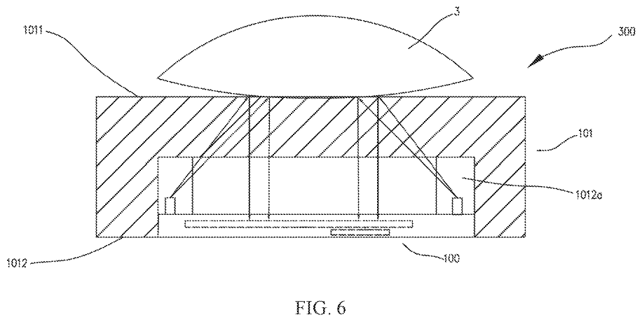

For a further improvement, as illustrated in FIG. 6, the rear surface 1012 defines a recess 1012a. The optical fingerprint recognition assembly 100 is received in the recess 1012a defined in the rear surface 1012. The recess 1012a is defined in the rear surface 1012 and the optical fingerprint recognition assembly 100 is received in the recess 1012a, that is, the optical fingerprint recognition assembly 100 is disposed in the display device 200 of the terminal 300. As a result, the optical fingerprint recognition assembly 100 does not occupy part of the display surface 1011 of the display screen 101.

The recess 1012a is defined in the light-shielding layer 1012a, that is, a portion of the display screen 101 corresponding to the recess 1012a is not provided with shielding materials, and thus the lights from the optical fingerprint recognition assembly 100 can pass through the display screen 101. The light sources 1 and the fingerprint module 2 both are received in the recess 1012a. The recess 1012a is substantially similar to the optical fingerprint recognition assembly in shape. For example, when the cross section of the optical fingerprint recognition assembly 100 is in a rectangular shape, the recess 1012a is also in a rectangular shape; when the cross section of the optical fingerprint recognition assembly 100 is in a round shape, the recess 1012a is also in a round shape.

Furthermore, as illustrated in FIG. 5 and FIG. 6, an orthographic projection of the recess 1012a on the display screen 101 falls in the display area 1011a of the display screen 101 for displaying images. The orthographic projection of the recess 1012a on the display screen 101 falls in the display area 1011a, and accordingly the optical fingerprint recognition assembly 100 does not occupy part of the non-display area 1011b of the display device 200 of the terminal 300. Therefore, a screen ratio of the display device 200 of the terminal 300 increases. Of course, in other embodiments, the recess 1012a may be defined in other positions. For example, the orthographic projection of the recess 1012a on the display screen 101 may fall in the non-display area 1011b.

When using the terminal 300, the optical fingerprint recognition assembly 100 is mounted in the recess 1012a of the display screen 101. The finger portion 3 containing the fingerprint presses on a portion of the display area 1011a directly facing the recess 1012a, where the fingerprint is referred as a fingerprint to be recognized. In response to press of the finger portion 3 containing the fingerprint, the light sources 1 of the optical fingerprint recognition assembly 100 emit lights. The lights reach the fingerprint touch surface 21a of the prism 21 and further reach the display screen 101 above the prism 21. When the lights from the light sources 1 reach the fingerprint, the total reflection occurs. The lights formed via the total reflection pass through the prism 21 and reach the image sensor 22. The image sensor 22 acquires the fingerprint image according to the lights formed via total reflection. The fingerprint controller 23 recognizes the fingerprint image transmitted by the image sensor 22. As such, the fingerprint recognition is performed.

The above is illustrative embodiments of the present disclosure. It should be noted that, those skilled in the art may make some improvements and modifications without deviating from the principles of the present disclosure. The improvements and modifications are deemed to be within the protection scope of the present disclosure.

What is claimed is:

1. An optical fingerprint recognition assembly comprising:
a fingerprint module comprising a prism, an image sensor, and a fingerprint controller, wherein the prism, the image sensor, and the fingerprint controller are encapsulated together, and wherein the prism comprises a fingerprint touch surface being configured to receive a fingerprint; and
a light source disposed outside the fingerprint module, wherein the light source is configured to emit lights reaching the fingerprint touch surface where a fingerprint to be recognized exists, and total reflection occurs when the lights reach the fingerprint to be recognized, and wherein lights formed via the total reflection pass through the prism and reach the image sensor; the image sensor being configured to acquire a fingerprint image according to the lights formed via the total reflection; the fingerprint controller being configured to recognize the fingerprint image received from the image sensor.

2. The optical fingerprint recognition assembly of claim 1, wherein an angel of incidence formed by the light emitted from the light source and a line perpendicular to the fingerprint touch surface ranges from 0 degree to 8 degrees.

3. The optical fingerprint recognition assembly of claim 1, wherein the light source surrounds the fingerprint module.

4. The optical fingerprint recognition assembly of claim 1, wherein the light source comprises a plurality of light emitting diodes (LEDs), wherein the plurality of LEDs surround the fingerprint module and are evenly spaced apart from each other.

5. The optical fingerprint recognition assembly of claim 4, wherein the fingerprint module has a cross section, wherein the cross section comprises two opposite long sides and two opposite short sides, wherein the two short sides are connected between the two long sides.

6. The optical fingerprint recognition assembly of claim 5, wherein the light source comprises six LEDs, wherein each of the long sides is provided with two of the LEDs, and each of the short sides is provided with one of the LEDs.

7. The optical fingerprint recognition assembly of claim 4, wherein the fingerprint module has a cross section in a round shape.

8. The optical fingerprint recognition assembly of claim 7, wherein the light source comprises four LEDs evenly disposed at a side surface of the fingerprint module.

9. The optical fingerprint recognition assembly of claim 1, wherein the light source is a plurality of infrared light sources, wherein the plurality of infrared light sources surround the fingerprint module and are evenly spaced apart from each other.

10. The optical fingerprint recognition assembly of claim 9, wherein the fingerprint module has a cross section, wherein the cross section comprises two opposite long sides and two opposite short sides, wherein the two short sides are connected between the two long sides.

11. The optical fingerprint recognition assembly of claim 10, wherein the light source comprises six infrared light sources, wherein each of the long sides is provided with two of the infrared light sources, and each of the short sides is provided with one of the infrared light sources.

12. The optical fingerprint recognition assembly of claim 1, further comprising a substrate, wherein the light source and the fingerprint module both are encapsulated on the substrate.

13. The optical fingerprint recognition assembly of claim 1, further comprising a flexible circuit board and a substrate disposed on the flexible circuit board, wherein the fingerprint module is encapsulated on the substrate, and the light source is disposed on the flexible circuit board.

14. The optical fingerprint recognition assembly of claim 1, wherein the prism, the image sensor, and the fingerprint controller are encapsulated via an epoxy molding compound plastic to form the fingerprint module.

15. The optical fingerprint recognition assembly of claim 1, wherein the fingerprint module is in a block shape as whole.

16. A display device comprising:
a display screen; and an optical fingerprint recognition assembly comprising:
a fingerprint module comprising a prism, an image sensor, and a fingerprint controller, wherein the prism, the image sensor, and the fingerprint controller are encapsulated together, and wherein the prism comprises a fingerprint touch surface being configured to receive a fingerprint, and
a light source disposed outside the fingerprint module, wherein the light source is configured to emit lights reaching the fingerprint touch surface where a fingerprint to be recognized exists, and total reflection occurs when the lights reach the fingerprint to be recognized, and wherein lights formed via the total reflection pass through the prism and reach the image sensor; the image sensor being configured to acquire a fingerprint image according to the lights formed via the total reflection; the fingerprint controller being configured to recognize the fingerprint image received from the image sensor; and
wherein the display screen attached to the optical fingerprint recognition assembly.

17. The display device of claim 16, wherein the rear surface is provided with a light-shielding layer made of light-shielding material.

18. The display device of claim 16, wherein the display screen comprises a rear surface facing away from the display screen, wherein the rear surface defines a recess, and the optical fingerprint recognition assembly is received in the recess defined in the rear surface.

19. The display device of claim 18, wherein an orthographic projection of the recess on the display screen falls in a display area of the display screen for displaying images.

20. A terminal comprising:
a display screen; and
an optical fingerprint recognition assembly comprising:
a fingerprint module comprising a prism, an image sensor, and a fingerprint controller, wherein the prism, the image sensor, and the fingerprint controller are encapsulated together, and wherein the prism comprises a fingerprint touch surface being configured to receive a fingerprint; and
a light source disposed outside the fingerprint module, wherein the light source is configured to emit lights reaching the fingerprint touch surface where a fingerprint to be recognized exists, and total reflection occurs when the lights reach the fingerprint to be recognized, and wherein lights formed via the total reflection pass through the prism and reach the image sensor; the image sensor being configured to acquire a fingerprint image according to the lights formed via the total reflection; the fingerprint controller being configured to recognize the fingerprint image received from the image sensor; and
wherein the display screen attached to the optical fingerprint recognition assembly.
